(19) United States
(12) Patent Application Publication
(10) Pub. No.: US 2020/0052379 A1
(43) Pub. Date: Feb. 13, 2020

(54) ANTENNA MODULE AND MOBILE TERMINAL

(71) Applicant: AAC Technologies Pte. Ltd., Singapore City (SG)

(72) Inventor: Peng Xu, Shenzhen (CN)

(21) Appl. No.: 16/524,079

(22) Filed: Jul. 28, 2019

(30) Foreign Application Priority Data
Aug. 12, 2018 (CN) 201810911503.2

(51) Int. Cl. H01Q 1/24; H01Q 3/24; H04B 1/00; H01Q 5/50; H01Q 1/50

(52) U.S. Cl. CPC H01Q 1/243; H01Q 3/24; H01Q 1/50; H01Q 5/50; H04B 1/006

(57) ABSTRACT

The present disclosure provides an antenna module and a mobile terminal. The antenna module includes a tuning switch and a matching circuit. The antenna module operates in one of a plurality of operating states by controlling the tuning switch, the antenna module operates in different LTE bands in different ones of the plurality of operating states, and in any of the plurality of operating states, the antenna module operates in a GPS band simultaneously. The antenna module provided by the present disclosure integrates an LTE antenna and a GPS antenna that have different bands into one antenna through the design of a matching circuit, and supports the low frequency band, the medium frequency band and the high frequency band of LTE and the frequency bands of the GPS antenna.

### TECHNICAL FIELD

The present disclosure relates to the field of communications technologies, and in particular, to an antenna module and a mobile terminal.

### BACKGROUND

With the development of mobile communication technology, mobile phones, PADs, and notebook computers have gradually become indispensable electronic products in life, and such electronic products have been additionally equipped with antenna modules to become electronic communication products with communication functions.

In the related art, a bottom or side of a metal frame is provided with a slit, and multiple-antenna layout schemes, such as a main antenna, a diversity antenna, a GPS antenna and a Wi-Fi antenna, are designed. Such layout scheme design has disadvantages of a single rigid board and a large space occupation, and there may be a case where an antenna in a certain band performs poorly due to environmental influences.

Therefore, it is necessary to provide an improved antenna module to solve the above problems.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of an antenna module according to an embodiment of the present disclosure;

FIG. 2 is a partial structural schematic diagram of the antenna module shown in FIG. 1 when viewed in a certain perspective;

FIG. 3 is a schematic circuit diagram of a specific embodiment of the antenna module shown in FIG. 1; and

FIG. 4 illustrates a comparison of a simulation result of a return loss of an antenna module according to the present disclosure with that of an antenna module in the related art.

### DESCRIPTION OF EMBODIMENTS

The present disclosure will be further illustrated with reference to the accompanying drawings and the embodiments.

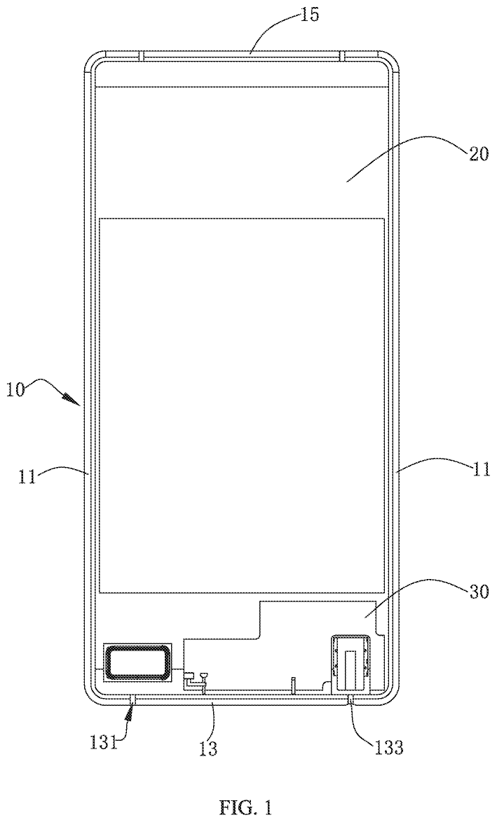

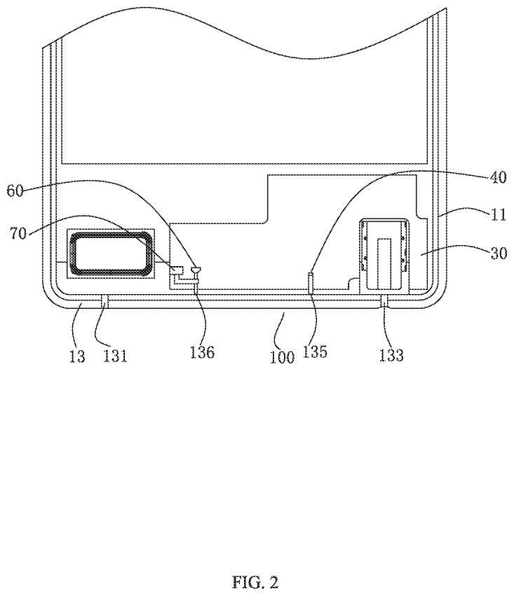

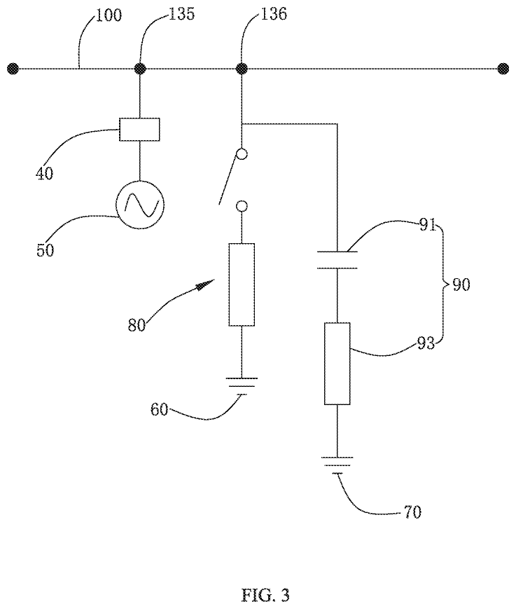

As shown in FIG. 1 to FIG. 3, an embodiment of the present disclosure provides an antenna module which can be applied to a mobile terminal, such as a mobile phone.

The antenna module includes a back shell 20, a metal middle frame 10 surrounding the back shell 20 along a circumferential direction of the back shell 20 and connected to the back shell 20, a main board 30, a feeding point 40 provided on the main board 30, a RF feeding source 50 connected to the feeding point 40, a first ground point 60, a second ground point 70, a tuning switch 80, and a matching circuit 90 provided in parallel with the tuning switch 80. The feeding point 40, the RF feeding source 50, the first ground point 60, the second ground point 70, the tuning switch 80, and the matching circuit 90 are provided on the main board 30.

The metal middle frame 10 includes two side frames 11 arranged opposite to each other, and a bottom frame 13 and a top frame 15 that are provided at two opposite ends of the side frame 11. That is, the top frame 15, one side frame 11, the bottom frame 13 and another side frame 11 are sequentially connected, head to tail, to form the metal middle frame 10. The bottom frame 13 is provided with a first slit 131 and a second slit 133, and it can be understood that the first slit 131 and the second slit 133 divide the bottom frame 13 into three segments. A portion located between the first slit 131 and the second slit 133 is a radiator 100.

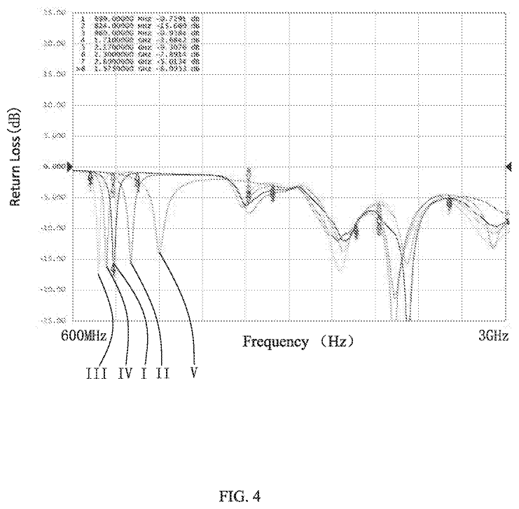

Referring to FIG. 4 in conjunction, the feeding point 40 is connected to the radiator 100, and a first end of the tuning switch 80 is connected to the radiator 100. A second end of the tuning switch 80 is connected to the first grounding point 60. A first end of the matching circuit 90 is connected to the first end of the tuning switch 80, and a second end of the matching circuit 90 is connected to the second ground point 70. In this way, the antenna provided by the present disclosure is formed.

In this embodiment, the feeding point 40 is connected to a first position 135 of the bottom frame 13, and the tuning switch 80 is connected to a second position 136 of the bottom frame 13. The first position 135 and the second position 136 are both located between the first slit 131 and the second slit 133. The first position 135 is provided close to the second slit 133, and the second position 136 is provided close to the first slit 131.

The matching circuit 90 includes a capacitor 91 and an inductor 93 that are connected in series. The capacitor 91 is used for isolating low frequency signals, and the inductor 93 is used to tune the GPS band. In this embodiment, a capacitance value of the capacitor 91 is smaller than 0.8 pF. As an example, the capacitance value of the capacitor 91 can be 0.5 pF, and the inductance value of the inductor 93 can be 10 nH.

The tuning switch 80 can be switched between different operating states, and in each operating state, the antenna module is controlled to operate in different LTE bands to achieve the broadband design requirements. Specifically, the tuning switch 80 can have a plurality of inductance access states corresponding to different inductance values, a plurality of capacitance access states corresponding to different capacitance values, and an open-circuit state and a short-circuit state, which are not limited in the present disclosure and may be set according to actual needs.

The matching circuit 90 is actually equivalent to a band pass filter, in which a small capacitor 91 is used to isolate low frequency signals and the inductor 93 is used to tune the GPS band, so as to achieve that the tuning switch 80 operates in any operating state and the antenna module can each operate in a GPS band simultaneously, thereby integrating an LTE antenna and a GPS antenna that have two different bands into one antenna.

In this embodiment, operating bands covered by the radiator 100 are 699-960 MHz, 1710-2690 MHz, and 1520-1620 MHz, and supports the low frequency band, the medium frequency band, the high frequency band of LTE and frequency bands of a GPS antenna. Moreover, when the antenna module operates in different LET bands, it also operates in a GPS band simultaneously. The antenna module provided by the present disclosure integrates an LTE antenna and a GPS antenna that have two different bands into one antenna through the design of a matching circuit, which can, in one aspect, greatly save antenna layout space so as to make the antenna design more flexible, and can, in another aspect, avoid problem of poor performance of the antenna caused by environmental influences. It should be noted that the LTE antenna herein can be used as a main antenna or as a diversity antenna.

Based on the above, FIG. 4 illustrates a comparison of a simulation result of the return loss of an antenna module provided by the present disclosure with that of an antenna module in the related art, in which curves I-IV are return loss graphs of the antenna module of the present disclosure in four different operating states, and the curve V is a return loss graph of an LTE antenna without being integrated with a GPS antenna in the related art. As can be seen from FIG. 4, the antenna module provided by the present disclosure always covers the operating band of the GPS antenna in any operating state.

The present disclosure also provides a mobile terminal, and the mobile terminal includes the antenna module described above.

What has been described above is only an embodiment of the present disclosure, and it should be noted herein that one ordinary person skilled in the art can make improvements without departing from the inventive concept of the present disclosure, but these are all within the scope of the present disclosure.

What is claimed is:

1. An antenna module, comprising:
a tuning switch; and
a matching circuit,
wherein the antenna module operates in one of a plurality of operating states by controlling the tuning switch, the antenna module operates in different LTE bands in different ones of the plurality of operating states, and in any of the plurality of operating states, the antenna module operates in a GPS band simultaneously.

2. The antenna module as described in claim 1, wherein the matching circuit is connected in parallel with the tuning switch, and has one end connected to ground and another end electrically connected to a radiator of the antenna module.

3. The antenna module as described in claim 1, wherein the matching circuit comprises a capacitor connected in series and configured to isolate low frequency signals, and the capacitor has a capacitance value smaller than 0.8 pF.

4. The antenna module as described in claim 3, wherein the antenna module is applied to a mobile terminal and further comprises a back shell, a metal middle frame surrounding the back shell along a circumferential direction of the back shell and connected to the back shell, a main board, and a feeding point, a first ground point and a second ground point that are provided on the main board, the tuning switch and the matching circuit being both provided on the main board,
the metal middle frame includes two side frames arranged opposite to each other and a bottom frame connecting the two side frames, the radiator is formed at the bottom frame, and the feeding point is connected to the radiator,
the tuning switch has a first end connected to the radiator and a second end connected to the first ground point,
the matching circuit has a first end connected to the first end of the tuning switch and a second end connected to the second ground point, and
the matching circuit further comprises an inductor connected in series with the capacitor, the inductor being configured to tune the GPS band.

5. The antenna module as described in claim 4, wherein the bottom frame is provided with a first slit and a second slit, and the radiator is a portion between the first slit and the second slit on the bottom frame.

6. A mobile terminal, comprising the antenna module as described in claim 1.
